(19) United States
(12) Patent Application Publication
(10) Pub. No.: US 2016/0344661 A1
(43) Pub. Date: Nov. 24, 2016

(54) SYSTEM AND METHOD FOR LINKING EXTERNAL COMPUTERS TO A SERVER

(71) Applicant: Justin T. Esgar, Wayne, NJ (US)

(72) Inventor: Justin T. Esgar, Wayne, NJ (US)

(21) Appl. No.: 15/157,122

(22) Filed: May 17, 2016

Related U.S. Application Data
(60) Provisional application No. 62/162,908, filed on May 18, 2015.

(51) Int. Cl. H04L 12/931; H04L 12/26

(52) U.S. Cl. CPC H04L 49/40; H04L 43/0817

(57) ABSTRACT

A data hub or switch capable of maintaining multiple ThunderBolt connections is described and taught. The switch may allow for multiple computers to connect to each other via ThunderBolt to create a ThunderBolt based network. Multiple computers connected to one another via ThunderBolt may allow for faster connections to a server. In one embodiment, the switch would allow offices to connect multiple user computers via ThunderBolt to one main and/or centrally located computer, such as a server, and/or other electronic device(s).

### CLAIM OF PRIORITY

This application claims priority to U.S. application Ser. No. 62/162,908 filed on May 18, 2015, the content of which is herein fully incorporated by reference in its entirety.

### FIELD OF THE EMBODIMENTS

The field of the present invention and its embodiments relate to a hub or switch used for creating an interconnected group of electronic devices. Namely, the switch has multiple high data transfer ports that enable peripheral devices to be coupled to a server computer for an increased degree of communications between the electronic devices.

### BACKGROUND OF THE EMBODIMENTS

ThunderBolt is a hardware interface that allows the connection of external peripherals to a computer or other electronic device. ThunderBolt technology is generally a bi-directional optical technology with theoretical data transfer speeds of up to 40 GB/s meaning that data can flow in both directions simultaneously at 40 GB/s. ThunderBolt advantageously combines PCI Express (PCIe) and DisplayPort (DP) into one serial signal, and further provides direct current (DC) power, all in one cable. Current technology allows up to six peripheral devices to be supported by one connector through various topologies and configurations.

U.S. Pat. No. 8,843,670 pertains to methods and apparatus that enable a community of devices having differing underlying protocols to stream media data such as video or audio data. In one exemplary embodiment, this invention enables IEEE 1394-compliant (“FireWire” enabled) devices to communicate across an Ethernet infrastructure, such as one enabled by the Ethernet AVB Standard(s). This enhances connectivity, and also supports obviating one or more physical ports within the device(s). In another embodiment, or more wireless transports are utilized.

U.S. Pat. No. 8,625,460 pertains to a fiber channel switch which enables end devices in different fabrics to communicate with one another while retaining their unique fiber channel Domain_IDs. The switch is coupled to a first fabric having a first set of end devices and a second fabric having a second set of end devices. The switch is configured to enable communication by the first set of end devices associated with the first fabric with the second set of end devices associated with the second set of end devices using the unique Domain_IDs of each of the first set and the second set of end devices. In one embodiment of the invention, the first and second fabrics are first and second Virtual Storage Array Networks (VSANs) respectively. In an alternative embodiment, the first fabric and the second fabric are separate physical fabrics.

U.S. Pat. No. 8,402,197 pertains to a method and structure(s) for providing a data path between and among nodes and processing elements within an interconnection fabric are described. More specifically, a device comprising a first circuit configured to couple between a first bus and a link is described. The circuit may he configured to operate as a bridge, support PCI configuration cycles, send outgoing information serially through the link in a format different from that of the first bus, and allow a host processor, communicating through the first bus, to selectively address one or more remote devices to which the device is configured to allow access. In some embodiments, the first circuit may support “spoof-proof” data protocols, and the device may operate in multiple modes including root bridge, leaf bridge, and gateway mode. Multiple addressing models may also be used. U.S. Patent Application 2014/0132835 pertains to an electronic device with a

ThunderBolt interface, a connecting method thereof, and a docking apparatus. The electronic device includes a first slot, a second slot, a ThunderBolt interface controller, and a DisplayPort splitter coupled to the ThunderBolt interface controller through a DisplayPort lane. The ThunderBolt interface controller receives a ThunderBolt interface stream through the first slot, parses the ThunderBolt interface stream into a data stream and a video stream, and determines whether an external device is inserted into the second slot. When the ThunderBolt interface controller determines that a transmission type of the external device is a DisplayPort interface and the electronic device needs to use the DisplayPort lane, the DisplayPort splitter parses the video stream into a first and a second stream and transmits the first and the second stream respectively to the electronic device and the external device through a first and a second transmission path.

U.S. Patent Application 2013/0145071 pertains to an electronic device and a method for switching mode of a ThunderBolt connector thereof. The electronic device includes a core unit, a PCIE device, a ThunderBolt control unit, a first switch circuit and a second switch circuit. The ThunderBolt control unit has a host mode and an end-point device mode. A common terminal of the first switch circuit is coupled to a PCIE port of the PCIE device. A first selection terminal of the first switch circuit is coupled to a first PCIE port of the core unit. A common terminal of the second switch circuit is coupled to a PCIE port of the ThunderBolt control unit. A first selection terminal of the second switch circuit is coupled to a second PCIE port of the core unit. A second selection terminal of the first switch circuit is coupled to a second selection terminal of the second switch circuit.

Various devices are known in the art. However, their structure and means of operation are substantially different from the present disclosure. The other inventions fail to solve all the problems taught by the present disclosure. The present invention and its embodiments provide for a data transfer hub that facilitates the creation of a ThunderBolt based network thereby providing faster data transfer speeds within a network. At least one embodiment of this invention is presented in the drawings below and will be described in more detail herein.

### SUMMARY OF THE EMBODIMENTS

The present invention and its embodiments generally apply to a data huh or switch capable of maintaining multiple ThunderBolt connections. The switch allows multiple computers to connect to each other via ThunderBolt to create a ThunderBolt based network. Multiple computers connecting via ThunderBolt may allow for faster connections to a server as compared to conventional data transfer methodologies.

In one embodiment, of the present invention, the switch would allow offices to connect multiple users computers via ThunderBolt to one main and/or centrally located computer or other electronic device. For example, in one embodiment, software with Mac OS X may be employed, thereby assigning all such interconnected computers an internet protocol address that would allow the computers to think the network created through the switch is a standard layer network. Using this configuration, Mac computers can connect to Mac servers over the ThunderBolt cable creating a much faster, in terms of data transfer, inter-office connection.

In a preferred embodiment, the switch may have at least four and preferably seven ThunderBolt ports, at least one Ethernet port, at least one power port, and at least one network communications port. It is preferential that one of the ThunderBolt ports will serve as the input port for the switch and the created network as a whole. While ThunderBolt is hi-directional, the specific “input” port will enables users to fully understand switch functionality creating a more seamless user experience. The at least one Ethernet port, and at least one communication port (i.e. Ethernet) may be configured to receive DHCP and, in some cases, be used for management purposes.

In the management controller, users may access the routing table (ARP table), observe and assign IP addresses, observe the computer names connected to the switch and further visualize on what port each computer is connected, and monitor data transfer speeds and errors. The power port will he for power, in some embodiments, however it is contemplated that with newer ThunderBolt versions providing even more power, although such a feature may not be required.

The switch preferably comprises at least two sections positioned on top of one another. This stackable design will allow for a clean office setting. At least one lighting element will surround each porthole enable one to recognize which ports are active (the light activates when cable is plugged into dock and computer). A small divot on the top of the switch will allow bottom half to sit flush and to allow for stacking.

In one embodiment of the present invention there is a data transfer hub having a base section with a top section coupled to the base section; at least two data transfer ports, wherein at least one of the data transfer ports is used as an input; at least one network communication port; at least one wireless transceiver; a power port.

In another embodiment of the present invention there is a data transfer system having a first hub comprising, a base section with a top section coupled to the base section, the top section having a recess disposed thereon, at least two data transfer ports, wherein at least one of the data transfer ports is used as an input, at least one network communication port, at least one wireless transceiver, a power port; and at least one additional hub comprising, a base section with a top section coupled to the base section, the top section having a recess disposed thereon, at least two data transfer ports, wherein at least one of the data transfer ports is used as an input, at least one network communication port, at least one wireless transceiver, a power port; wherein the at least one additional hub is configured to reside on a top surface of the first hub or the first hub is configured to reside on a top surface of the at least one additional hub.

In general, the present invention succeeds in conferring the following, and others not mentioned, benefits and Objectives.

It is an object of the present invention to provide an apparatus that enables the coupling of multiple electronic devices.

It is an object of the present invention to provide an apparatus that is compact and lightweight.

It is an object of the present invention to provide an apparatus provides increased data transfer speeds.

It is an object of the present invention to provide an apparatus enable inter-office connections.

It is an object of the present invention to provide an apparatus that allows for bi-directional sharing of information.

It is an object of the present invention to provide an apparatus that is user friendly.

### BRIEF DESCRIPTION OF THE DRAWINGS

FIG. 1 is a front view of an embodiment of the present invention.

FIG. 2 is a back view of an embodiment of the present invention.

FIG. 3 is a top view of an embodiment of the present invention.

FIG. 4 is a bottom view of an embodiment of the present invention.

FIG. 5 is a front view of an alternate embodiment of the present invention.

FIG. 6 is a back view of an alternate embodiment of the present invention.

### DESCRIPTION OF THE PREFERRED EMBODIMENTS

The preferred embodiments of the present invention will now be described with reference to the drawings. identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

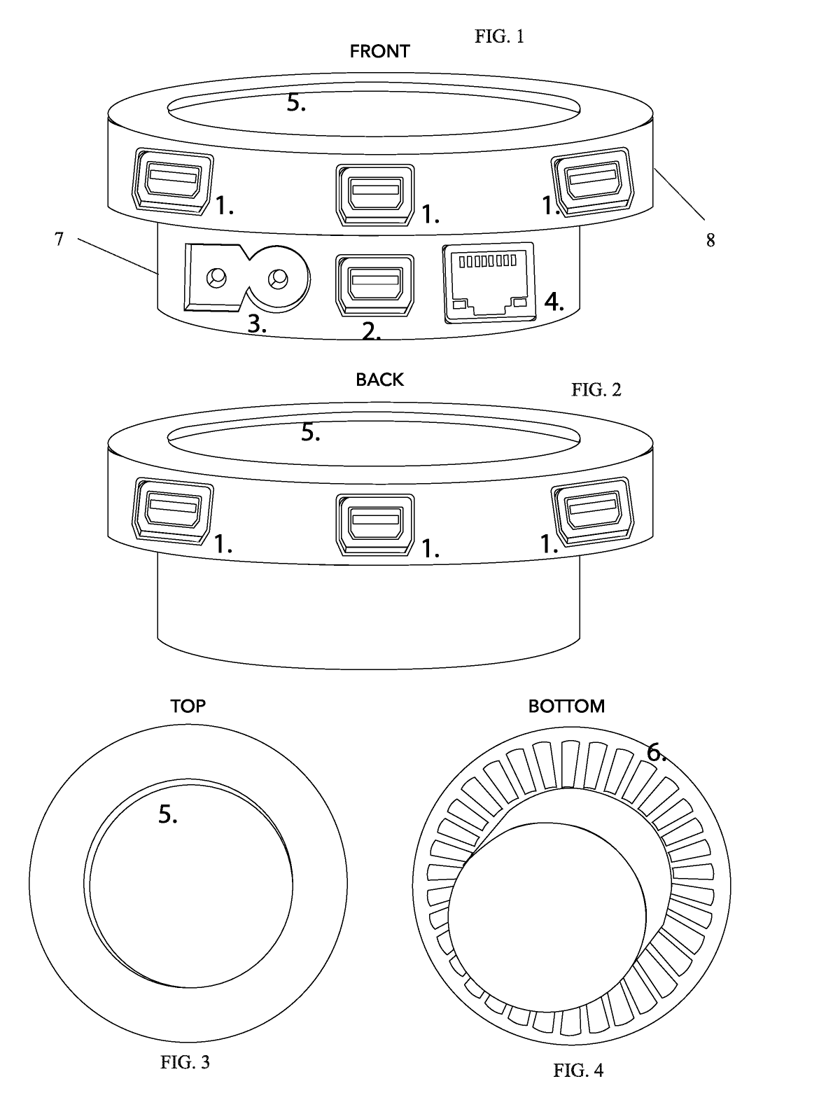

Referring to FIG. 1, there is a front view of an embodiment of the present invention. The embodiment generally has a base section 7 and a top section 8. The base section 7 is coupled to the top section 8 and in some embodiments may be removable from one another.

Disposed around a periphery of the top section 8 are a number of data transfer ports 1. These data transfer ports I are preferably configured to receive a ThunderBolt connector. In some embodiments, status light emitting diodes, or other light sources, at least partially surround each of the data ports 1. These light sources signify when an operative connection has been made to the port and to a secondary electronic device. The number and configuration of these ports may vary, but as shown in FIGS. 1 and 2, there are six ports disposed around the periphery in other embodiments, there may be between about two to about ten of such ports. In some embodiments it may be preferable to have them spaced equidistant from one another.

Further, the top of the top section 1 has a recess 5 thereon as shown in at least FIGS. 1 and 3. The recess 5 is configured to have similar dimensions to that of the base section 7. This enables the base section 7 (see FIG. 4) of one hub to fit snugly into the recess 5 of another hub thereby providing stacking of the devices. This enables multiple hubs to be conveniently used in an area while taking up little real estate. The depth of the recess should be such that it enables a secure connection or placement to be made without obscuring any of the features of the huh positioned thereon.

In the base section 7, there is a power port 3, an input data transfer port 2, and a communication network port 4. The power port 3 enables the hub to establish a powered electrical connection, enabling operation of the hub itself. In some instances, the power port 3 may not be required and a power source may be integrated with the hub. In such embodiments, the electrical, or other power source, is supplied by the data transfer cables themselves. Thus, such cables would be capable of supplying both data and electrical power.

The communications port 4 is preferably configured to receive an Ethernet connector. In some embodiments, one may concatenate multiple Ethernet wiring bundles into a single Ethernet wire and port thereby providing more bandwidth to the system. The communications port 4 may be configured to receive DHCP thereby enabling management of the device as a whole. The management controller may provide for access to the routing table, enable observation of and assignment of IP addresses, observation of computers and computer names coupled to the hub, and observe data transfer speeds and errors. Other functionality may also be contemplated and include more or less than the functionality described herein.

The input data port 2 is capable of transferring data bi-directionally, as are all of the other data ports. However, the inclusion of the input data port 2 conforms to the configurations expected by consumers when accessing such a system, and will further enable the individuals to understand how the hubs functions in the transfer of data.

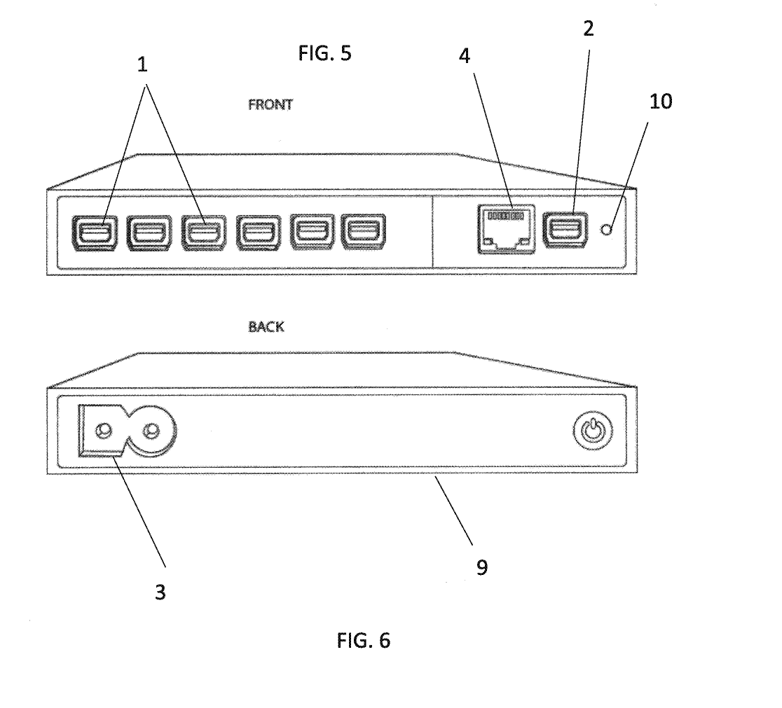

Referring now to FIGS. 5 and 6, there is an alternate embodiment of the present invention configured to be rack mountable. Such an embodiment may be capable of residing in a rack along with a server or in a standalone rack. Much of the functionality between this particular embodiment and that previously described is retained. However, the hub may further comprise at least one light source embodied as a status light emitting diode (LED) configured to signify an operational state of the hub. In at least one embodiment, this allows for a visual inspection to ascertain whether the device is properly paired to another device. In some embodiments, each port has its own light source.

The hub described in FIGS. 1-6 may have at least one wireless transceiver or beacon contained therein or coupled thereto, with the wireless transceiver being capable of sending and receiving wireless signals. A number of wireless protocols may be implemented in embodiments of the invention including but not limited to Wi-Fi, Bluetooth, ANT, ZigBee, and the like or any combination thereof Any type of electronic device may be capable of communicating with the hub on a user or administrative basis including but not limited to laptop computers, desktop computers, tablets, PDAs, gaming systems, smart phones, smart watches, multimedia players, and the like or any combination thereof.

The hub may be made from a number of materials including plastics, metals, composites, rubbers, and the like or any combination thereof. In a preferred embodiment, the hub structure (i.e. top section and base section) are formed from aluminum or other lightweight, thermally conductive metals. Not only does this provide for an aesthetically pleasing appearance, but can help regulate the temperatures of the hub. In addition, some embodiments may have heat vents 6, as shown in FIG. 4, to help further disperse any heat generated by the hub. Proper operating temperatures will ensure the operability and survivability of the components of the hub.

Further, it is contemplated that the hub may be accessed and controlled remotely via the internet or mobile application or other suitable means. Thus, a remote manager of the hub system can control and configure the hub without being in the physical presence of the huh of having to establish a physical, hard-lined connection with the hub. From the remote manager dashboard, a manager may be able to readily configured the operative nature and parameters of the hub including but not limited to privacy settings, individual port settings, data flow minimums and maximums, and the like or some combination thereof.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A data transfer hub comprising:
a base section with a top section coupled to the base section;
at least two data transfer ports,
wherein at least one of the data transfer ports is used as an input;
at least one network communication port;
at least one wireless transceiver; and
a power port.

2. The hub of claim 1 wherein the at least two data transfer ports are configured to receive a ThunderBolt style connector.

3. The hub of claim 1 wherein the at least one network communication port is an Ethernet port.

4. The hub of claim 1 wherein the top section has a recess configured to receive a base section of a second data transfer hub.

5. The hub of claim 1 wherein there are seven data transfer ports.

6. The hub of claim 1 wherein the input is disposed in the base section and other data transfer ports are disposed in the top section.

7. The hub of claim I further comprising at least one status light source.

8. A data transfer system comprising:
a first hub comprising,
a base section with a top section coupled to the base section, the top section having a recess disposed thereon,
at least two data transfer ports,
wherein at least one of the data transfer ports is used as an input,
at least one network communication port,
at least one wireless transceiver,
a power port; and
at least one additional hub comprising,
a base section with a top section coupled to the base section, the top section having a recess disposed thereon,
at least two data transfer ports,
wherein at least one of the data transfer ports is used as an input,
at least one network communication port,
at least one wireless transceiver,
a power port;
wherein the at least one additional huh is configured to reside on a top surface of the first hub or the first hub is configured to reside on a top surface of the at least one additional hub.

9. A data transfer hub comprising:
a plurality of data transfer ports being configured to receive a ThunderBolt style connector,
wherein at least one of the plurality of data transfer ports is configured to be used as an input;
at least one network communication port;
at least one wireless transceiver; and
a power port.

10. The hub of claim 9 wherein the hub is configured to be mounted in a rack system.

11. The hub of claim 9 further comprising at least one light source configured to display an operative state of the hub.
